(19) United States
(12) Patent Application Publication
(10) Pub. No.: US 2010/0027743 A1
(43) Pub. Date: Feb. 4, 2010

(54) APPARATUS AND METHOD FOR DETERMIINING A DETECTOR ENERGY WEIGHTING FUNCTION OF A DETECTION UNIT

(75) Inventors: Klaus Jurgen Engel, Aachen (DE); Christian Baeumer, Aachen (DE); Guenter Zeitler, Aachen (DE); Christoph Herrmann, Aachen (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/514,907

(22) PCT Filed: Nov. 19, 2007
(86) PCT No.: PCT/IB07/54692

§ 371 Date: May 14, 2009

(30) Foreign Application Priority Data
Nov. 21, 2006 (EP) 06124472.9

(51) Int. Cl. G01N 23/04; G06F 19/00

(52) U.S. Cl. 378/62; 702/116

(57) ABSTRACT

The invention relates to an apparatus for determining a detector energy weighting function of a detection unit (6). The apparatus comprises a determination unit (21) for determining a spectral response function of the detection unit (6) and a calculation unit (22) for determining the detector energy weighting function by integrating the product of the spectral response function of the detection unit (6) and a given ideal detector energy weighting function.

### FIELD OF THE INVENTION

The invention relates to an apparatus and a method for determining a detector energy weighting function of a detection unit. The invention relates further to an imaging system using the determined detector energy weighting function.

### BACKGROUND OF THE INVENTION

It is known, for example, from R. E. Alvarez, A. Macovski, Phys. Med. Biol. 21(5), 733 (1976), to relate a spectrum of radiation impinging on a detection unit to the measured detection signal by using a detector energy weighting function. This relation can, for example, be formulated by following equation:

M=c·∫dE·ƒ(E)·D(E), (1)

wherein M denotes the measured detection signal, c a known proportional constant, ƒ(E) the detector energy weighting function and D(E) the spectrum of radiation impinging on the detection unit. The measured detection signal is known, and the detector energy weighting function is generally defined as a detector energy weighting function of an ideal detector. Thus, since the measured detection signal and the detector energy weighting function of an ideal detector, i.e. the ideal detector energy weighting function, are known, equation (1) can be used for recalculating material properties of an examined object by examination of the spectrum of radiation impinging on the detection unit.

But, in reality, an ideal detection unit is not present. The above mentioned approach does not consider physical detector effects for the signal processing, like charge sharing or crosstalk between pixels of the detection unit. This leads, however, to a wrong interpretation of the measured detection signal. For example, in the special case of a photon counting multi-threshold CZT pixel detector, a number of physical effects result in a wrong classification of photons. In particular, crosstalk effects could spread parts of the total energy to neighbouring pixels (charge sharing or K-fluorescence), which results e.g. in two photon counts in two pixels instead of one, both with energies lower than the energy of the original photon. Furthermore, a part of the photon energy could escape by fluorescence or scatter processes, yielding an underestimation of the photon energy. Also, two coincident incident photons could be detected as one photon (“pile-up” effect, over-estimation of energy). Furthermore, statistical effects of charge detection result to energy broadening. A photon counting multi-threshold CZT detector is, for example, disclosed in V. B. Cajipe, R. Calderwood, M. Clajus, B. Grattan, S. Hayakawa, R. Jayaraman, T. O. Tumer and O. Yossifor, “Multi-Energy X-ray Imaging with Linear CZT Pixel Arrays and Integrated Electronics,” 14th Intl. Workshop on Room-Temperature Semiconductor X-Ray and Gamma-Ray Detectors, Rome, Italy, Oct. 18-22, 2004.

These effects of a realistic detector modify the measured detection signals such that, if the spectrum of radiation impinging on the detection unit is recalculated by using the ideal detector energy weighting function, the determined spectrum of radiation impinging on the detection unit differs from the real spectrum of radiation impinging on the detection unit. Furthermore, if this determined spectrum of radiation is used for reconstructing an image of a region of interest, for example, if the detection unit is a detector of a computed tomography (CT) system, the reconstructed image comprises artefacts caused by corrupted determined spectra of radiation.

### SUMMARY OF THE INVENTION

It is an object of the present invention to provide an apparatus and a method for determining a detector energy weighting function of a detection unit, which considers detector effects like charge sharing or crosstalk, particularly to allow determining the spectrum of radiation impinging on the detection unit with improved quality.

In a first aspect of the present invention an apparatus for determining a detector energy weighting function of a detection unit is presented, wherein the apparatus comprises:

a determination unit for determining a spectral response function of the detection unit,

a calculation unit for determining the detector energy weighting function by integrating the product of the spectral response function of the detection unit and a given ideal detector energy weighting function.

The invention is based on the idea that the determined spectral response function contains information about effects of the detection unit, in particular about the above mentioned physical effects like charge sharing and crosstalk, and that therefore the integration of the product of the determined spectral response function of the detection unit and a given ideal detector energy weighting function yields a detector energy weighting function which considers these effects, i.e. that the detector energy weighting function determined in accordance with the invention is a realistic detector energy weighting function.

It is preferred, that the determination unit comprises a radiation source capable of illuminating the detection unit with monochromatic radiation having an adjustable wavelength, that the determination unit is adapted for illuminating the detection unit successively with monochromatic radiation of different wavelengths of the radiation source, that the determination unit is adapted for determining the spectral response function by detecting detection signals of the detection unit while being illuminated successively with monochromatic radiation of different wavelengths. Since the spectral response function determined in this way contains the above-mentioned effects of the detection unit with a high reliability, the detector energy weighting function, which is calculated by using this spectral response function, has an improved quality.

It is also preferred that the determination unit is adapted for determining the spectral response function by simulating detection signals of the detection unit, which would be detected, if the detection unit is illuminated successively with monochromatic radiation of different wavelengths. This simulation considers the physical and electronic effects of the detection unit like charge sharing or crosstalk in a realistic manner. This simulation allows therefore determining the spectral response function without needing monochromatic radiation. Furthermore, this simulation can be used together with the above mentioned experimental determination of the spectral response function, i.e. with the illumination of the detection unit successively with monochromatic radiation of different wavelengths and the detection of the corresponding detection signals, in order to further improve the quality of the spectral response function, and, thus, of the calculated detector energy weighting function.

In an embodiment, the detection unit is adapted for providing energy-resolved detection signals for a plurality of energy bins, that the apparatus is adapted for determining for each energy bin a detector energy weighting function, that the calculation unit is adapted for determining the detector energy weighting function for an energy bin by integrating the product of the spectral response function of the detection unit and a given ideal detector energy weighting function of the respective energy bin. It is preferred that the calculation unit is adapted such that the given ideal detector energy weighting function of an energy bin is one for energies within the respective energy bin and zero for energies outside of the respective energy bin. Since for each energy bin a detector energy weighting function is determined, which considers the effects of the respective energy bin, the determined detector energy weighting functions consider the effects of each respective energy bin, which further improves the quality of the determined detector energy weighting functions.

It is a further object of the present invention to provide an imaging system for imaging a region of interest, which considers effects of a detection unit like charge sharing or crosstalk in order to improve the quality of reconstructed images of the region of interest.

In an aspect of the present invention an imaging system for imaging a region of interest is presented, wherein the imaging system comprises:

a radiation-and-detection unit comprising a radiation unit for emitting radiation and a detection unit for detecting the radiation after passing through the region of interest, the radiation-and-detection unit being adapted for generating a plurality of energy dependent detection signals, the detection signals comprising different components, the imaging system being provided with a detector energy weighting function, the detector energy weighting function being determined by determining a spectral response function of the detection unit and by integrating the product of the spectral response function of the detection unit and a given ideal detector energy weighting function,

a calculation unit for determining at least one attenuation component by solving a system of equations for the plurality of energy dependent detection signals, using a model for the detection signals describing a detection signal as a combination of the detector energy weighting function, and of different attenuation properties contributing with corresponding attenuation components to the detection signal,

a reconstruction unit for reconstructing an image of the region of interest from the determined at least one attenuation component.

Since the detector energy weighting function used by the calculation unit considers the effects of the detection unit like charge sharing or crosstalk, the at least one attenuation component is determined with a high quality and therefore, since the reconstruction unit uses this at least one high quality attenuation component for reconstructing an image of the region of interest, the reconstructed image has a high quality, i.e., in particular, artifacts caused by the effects of the detection unit like charge sharing or crosstalk are reduced or no more present.

In an embodiment, the radiation unit is a polychromatic radiation source for emitting polychromatic radiation, and the detection unit is an energy-resolving detector for detecting the radiation after passing through the region of interest and for providing energy dependent detection signals by providing a plurality of energy-resolved detection signals for a plurality of energy bins, the imaging system being provided with a detector energy weighting function for each energy bin, the detector energy weighting function of an energy bin being determined by determining a spectral response function of the detection unit and by determining a detector energy weighting function of an energy bin by integrating the product of the spectral response function of the detection unit and a given ideal detector energy weighting function of the respective energy bin. Since for each energy bin a detector energy weighting function is determined, the effects of each energy bin of the detection unit are considered by the respective detector energy weighting function, which further improves the quality of the at least one attenuation component, which is calculated by using the detector energy weighting functions, and, thus, the quality of the reconstructed image is further improved.

It is further preferred, that the radiation unit is a polychromatic radiation source for emitting polychromatic radiation, wherein the spectrum of the polychromatic radiation is changeable (e.g. tube voltage switching or switched filtering), wherein the radiation-and-detection unit is adapted for providing energy dependent detection signals by illuminating the region of interest by different spectra of polychromatic radiation and by detecting the radiation having the different spectra of polychromatic radiation after passing through the region of interest. A radiation unit having a changeable spectrum of polychromatic radiation such that energy dependent detection signals can be provided by illuminating the region of interest by different spectra of polychromatic radiation allows providing energy dependent detection signals without the need of a energy-resolving detection unit. This allows using a standard non-energy resolving detection unit. In this case, the spectral response function is preferentially determined by simulation, in order to use this spectral response function to determine the detector energy weighting function in accordance with the invention.

Attenuation components are preferentially the K-edge component, the photo-electric component and the Compton component. Thus, the detection signal is preferentially modeled as a combination of the K-edge effect of an object or a substance within the region of interest, the photo-electric effect and the Compton effect and of the detector energy weighting function. The calculation unit is therefore preferentially able to determine the K-edge component, the photo-electric component and the Compton component. Each of theses components can be used to reconstruct an image of the region of interest. It is preferred that the K-edge component is used for reconstructing an image of the region of interest. This allows reconstructing only the K-edge component of the object or the substance, like a contrast agent, within the region of interest without being disturbed by other effects like the photo-electric effect and the Compton effect.

It is further preferred that in the region of interest several materials having different spectral absorptions are present, wherein a detection signal can be described as a combination of the detector energy weighting function and of the attenuation effects relating to the different spectral absorptions of the several materials and wherein this attenuation effects contribute with corresponding attenuation components to the detection signals. These several materials are, for example, bone and soft tissue of a patient, and potentially contrast agents. Since, in this preferred embodiment, an attenuation component resulting from a first material, for example, resulting from bones, can be distinguished from an attenuation component caused by a second material, which is, for example, a contrast agent, this embodiment allows reconstructing an image showing only the contrast agent and reconstructing a further image, which shows only bones, by using only the respective attenuation components of the detection signals.

The imaging system is preferentially a spectral computed tomography system. The use of the spectral computed tomography system in accordance with the invention allows to determine images, which correspond to at least one attenuation component, by known computed tomography reconstruction methods, like filtered backprojection.

In a further aspect of the present invention a method for determining a detector energy weighting function of a detection unit is presented, wherein the method comprises the following steps:

determining a spectral response function of the detection unit by a determination unit,

determining the detector energy weighting function by integrating the product of the spectral response function of the detection unit and a given ideal detector energy weighting function by a calculation unit.

In a further aspect of the invention an imaging method for imaging a region of interest is presented, wherein the imaging method comprises the following steps:

emitting radiation by a radiation unit of a radiation-and-detection unit and detecting the radiation after passing through the region of interest by a detection unit of the radiation-and-detection unit, generating a plurality of energy dependent detection signals by the radiation-and-detection unit, the detection signals comprising different components, the imaging system being provided with a detector energy weighting function, the detector energy weighting function being determined by determining a spectral response function of the detection unit and by integrating the product of the spectral response function of the detection unit and a given ideal detector energy weighting function,

determining at least one attenuation component by solving a system of equations for the plurality of energy dependent detection signals, using a model for the detection signals describing a detection signal as a combination of the detector energy weighting function and of different attenuation properties contributing with corresponding attenuation components to the detection signal, by a calculation unit,

reconstructing an image of the region of interest from the determined at least one attenuation component by a reconstructing unit.

In a further aspect of the invention a computer program for determining a detector energy weighting function of a detection unit is presented, comprising program code means for causing a computer to carry out the steps of the method as claimed in claim 9 when the computer program is carried out on a computer controlling an apparatus as claimed in claim 1.

In a further aspect of the invention a computer program for imaging a region of interest is presented, comprising program code means for causing a computer to carry out the steps of the method as claimed in claim 10 when the computer program is carried out on a computer controlling an imaging system as claimed in claim 6.

Is shall be understood that the apparatus for determining a detector energy weighting function of a detection unit of claim 1, the imaging system for imaging a region of interest of claim 6, the method for determining a detector energy weighting function of a detection unit of claim 9, the imaging method for imaging a region of interest of claim 10, the computer program for determining a detector energy weighting function of a detection unit of claim 11 and the computer program for imaging a region of interest of claim 12 have similar or/and identical preferred embodiments as defined in the dependent claims.

### BRIEF DESCRIPTION OF THE DRAWINGS

These and other aspect of the invention will be apparent from and elucidated with reference to the embodiments described herein after. In the following drawings

FIG. 1 shows schematically a representation of an imaging system in accordance with the invention.

FIG. 2 shows schematically a flow chart illustrating a method for imaging a region of interest in accordance with the invention.

FIG. 3 shows schematically a (filtered) spectrum of a polychromatic X-ray source (filtered bremsstrahlungs-spectrum).

FIG. 4 shows schematically the energy behaviour (spectra) of the attenuation coefficients of the photo-electric effect, Compton effect in general and of two materials within the region of interest.

FIG. 5 shows schematically an apparatus for determining a detector energy weighting function of detection unit in accordance with the invention.

FIG. 6 shows schematically a flow chart illustrating a method for determining a detector energy weighting function of a detection unit in accordance with the invention.

FIG. 7 shows schematically a spectral response function.

FIG. 8 shows schematically an ideal detector energy weighting function and a detector energy weighting function in accordance with the invention.

### DETAILED DESCRIPTION OF EMBODIMENTS

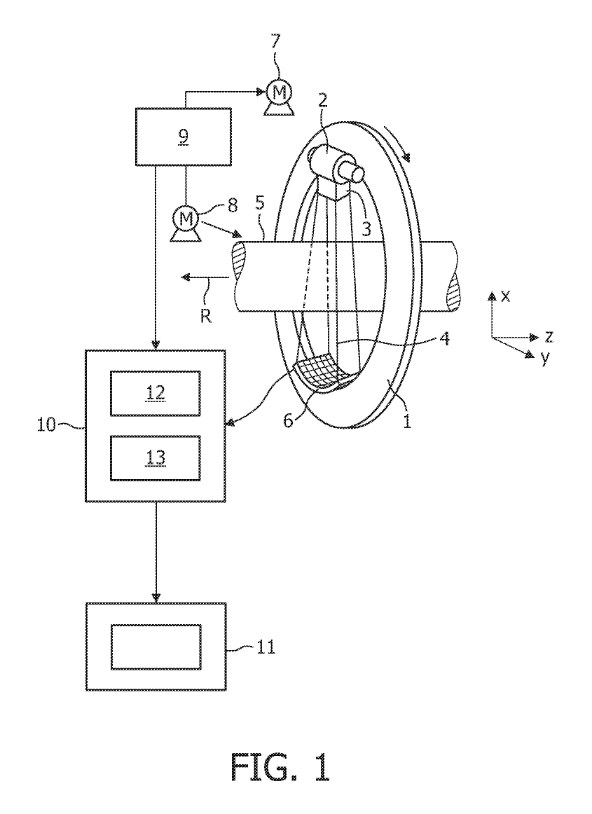

The imaging system shown in FIG. 1 is a spectral computed tomography system (CT system). The CT system includes a gantry 1 which is capable of rotation about an axis of rotation R which extends parallel to the z direction. A polychromatic radiation source 2, which is in this embodiment an X-ray tube emitting polychromatic X-ray radiation, is mounted on the gantry 1. The X-ray source 2 is provided with a collimator and a filter device 3, which forms in this embodiment a conical radiation beam 4 from the radiation produced by the X-ray tube 2. The radiation traverses an object (not shown), such as a patient, in a region of interest in an examination zone 5, which is in this embodiment cylindrical. After having traversed the examination zone 5, the X-ray beam 4 is incident on an energy-resolving detection unit 6, which comprises in this embodiment a two-dimensional detection surface. The energy-resolving detection unit 6 is mounted on the gantry 1. The X-ray source 2 and the energy resolving detection unit 6 form a radiation-and-detection unit for generating a plurality of energy dependent detection signals.

The imaging system comprises a driving device having two motors 7, 8. The gantry 1 is driven at a preferably constant but adjustable angular speed by the motor 7. The motor 8 is provided for displacing the object, for example, a patient, who is arranged on a patient table in the examination zone 5, parallel to the direction of the axis of rotation R or the z axis. These motors 7, 8 are controlled by a control unit 9, for instance, such that the radiation source 2 and the examination zone move relative to each other along a helical trajectory (spiral CT). However, it is also possible that the object or the examination zone 5 is not moved, but that only the X-ray source 2 is rotated, i.e., that the radiation source moves along a circular trajectory relative to the object. Furthermore, in an other embodiment, the collimator and filter device 3 can be adapted for forming a fan beam and the energy-resolving detection unit 6 can also be a one-dimensional detector.

Energy-resolving detection units work, for example, on the principle of counting the incident photons and output a signal that shows the number of photons in a certain energy area (window, bin). Such an energy-resolving detection unit is, for example, described in Llopart, X., et al. “First test measurements of a 64 k pixel readout chip working in a single photon counting mode”, Nucl. Inst. and Meth. A, 509 (1-3): 157-163, 2003 and in Llopart, X., et al., “Medipix2: A 64-k pixel readout chip with 55 μm square elements working in a single photon counting mode”, IEEE Trans. Nucl. Sci. 49(5): 2279-2283, 2002. Preferably, the energy-resolving detection unit is adapted such that it provides at least two energy resolved detection signals for at least two different energy bins allowing for a reconstruction of e.g. photo effect, Compton effect and/or edges images. However, it is advantageous to have an even higher energy resolution in order to enhance the sensitivity and noise robustness of the CT imaging system.

The data acquired by the detection unit 6 are provided to an image generation device 10 for generating an image of the region of interest. The image generation device 10 comprises a calculation unit 12 for determining at least one attenuation component and a reconstruction unit 13 for reconstructing an image of the region of interest using the determined at least one attenuation component.

The reconstructed image can finally be provided to a display 11 for displaying the image. Also the image generation device is preferably controlled by the control unit 9.

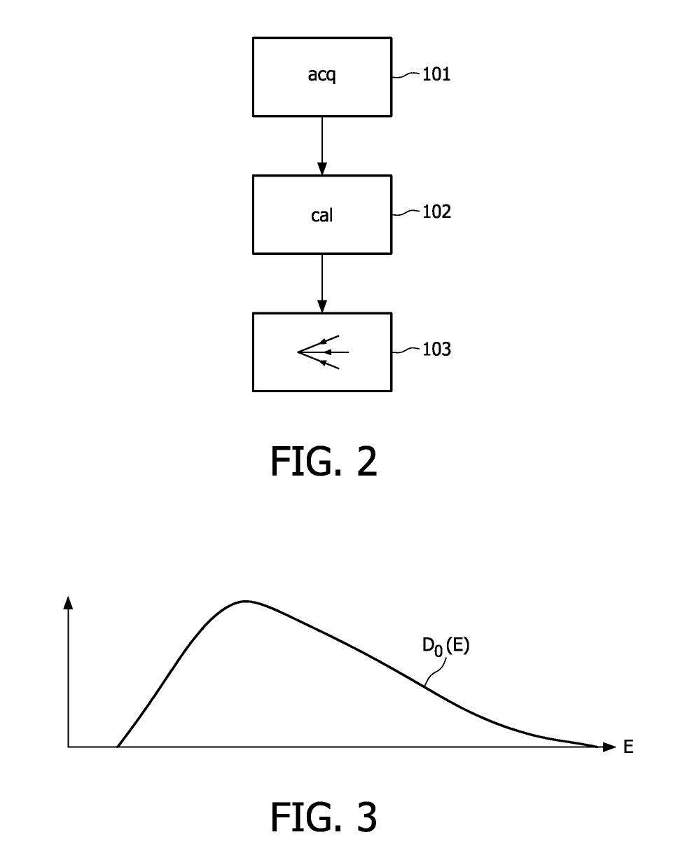

In the following, an embodiment of an imaging method for imaging a region of interest in accordance with the invention will be described in more detail with reference to FIG. 2.

In step 101, the X-ray source 2 rotates around the axis of rotation R or the z direction, and the object is not moved, i.e. the X-ray source 2 travels along a circular trajectory around the object. In an other embodiment, the X-ray source can move along another trajectory, for example, a helical trajectory, relative to the object. The X-ray source 2 emits polychromatic X-ray radiation traversing an object in the region of interest. The object is, for example, a human heart of a patient, wherein a contrast agent, like an iodine or gadolinium based contrast agent, has been injected in advance. The X-ray radiation, which has passed the object and the substance within the object is detected by the detection unit 6, which generates detection signals. Detection signals, which correspond to the same position of the X-ray source 2 and of the detection unit 6 relative to the object and which have been acquired at the same time, form a projection.

The acquired detection signals are inputted to the calculation unit 12 of the image generation device 10. In step 102, the calculation unit 12 determines at least one attenuation component of the detection signals.

The detection signals contain information of different attenuation components related to different attenuation properties of the object. These different attenuation properties of the object are, for example, caused by different attenuation effects, like the photo-electric effect, the Compton effect or the K-edge effect, and/or by different absorption properties of different materials within the region of interest. Consequently, the attenuation components are, for example, a K-edge component, a photo-electric component and a Compton component. Furthermore, if there are different kind of materials present within the region of interest, for example, materials having different spectral absorption characteristics, like soft tissue and bones, the attenuation components describe the attenuation of the different kinds of material present within the region of interest, for example, the attenuation caused of soft tissue, bone and possibly also the attenuation caused by a contrast agent. In the latter case, the detection signals can be described as a combination of a soft tissue component, a bone component and a contrast agent component. In general, the detection signals can be described as a combination of a set of attenuation components (also known as base functions of the attenuation coefficient) of the different materials present within the region of interest.

The input to the calculation unit 12 are energy-resolved detection signals Mᵢ for a plurality, in this embodiment at minimum four, energy bins bᵢ. Each energy bin bᵢ has a detector energy weighting function, which is sometimes also referred to as spectral sensitivity, ƒᵢ (E). The detector energy weighting functions ƒᵢ (E) are stored in the calculation unit 12 and have been provided by an apparatus for determining a detector energy weighting function of a detection unit, which will be described further below. The energy-resolved detection signal Mᵢ can be modeled by following equation:

$${M}_{i} = {c}_{i} {\int }_{{E}_{i}}^{{E}_{u}} d ED ( E ) {f}_{i} ( E ) \qquad ( 2 )$$

The proportional constant cᵢ for the i-th energy bin is known, for example, from calibration measurements without a phantom. Eᵤ and E₁ being the upper and lower threshold energy, respectively, limiting the spectrum of radiation impinging on the detection unit.

The term D(E) denotes the spectrum of radiation impinging on the detection unit 6, which can be described by following equation:

$$D ( E ) = {D}_{0} ( E ) \cdot exp ( - {\sum }_{j = 1}^{{N}_{B}} {A}_{j } \cdot {μ}_{j} ( E ) ) , \qquad ( 3 )$$

wherein D₀ (E) denotes the emission spectrum of the polychromatic X-ray tube 2, Aⱼ=∫ρⱼ(s) ds denotes the integral mass density of an attenuation component j along a projection line described by a parameter s, μⱼ (E) denotes the energy dependent attenuation coefficient corresponding to the attenuation component j, and N_{B} denotes the number of attenuation components. The attenuation coefficients μⱼ(E) are, for example, the attenuation coefficient of the photo-electric effect, the attenuation coefficient of the Compton effect and the attenuation coefficients of different materials within the region of interest showing K-edges.

A combination of equations (2) and (3) yields the following equation for the energy resolved detection signals Mᵢ:

$${M}_{i} = {c}_{i} \cdot {\int }_{{E}_{l}}^{{E}_{u}} d {Ef}_{i} ( E ) {D}_{0} ( E ) \cdot exp ( - {{\sum }_{j = 1}}^{{N}_{B}} {A}_{j } \cdot {μ}_{j} ( E ) ) \qquad ( 4 )$$

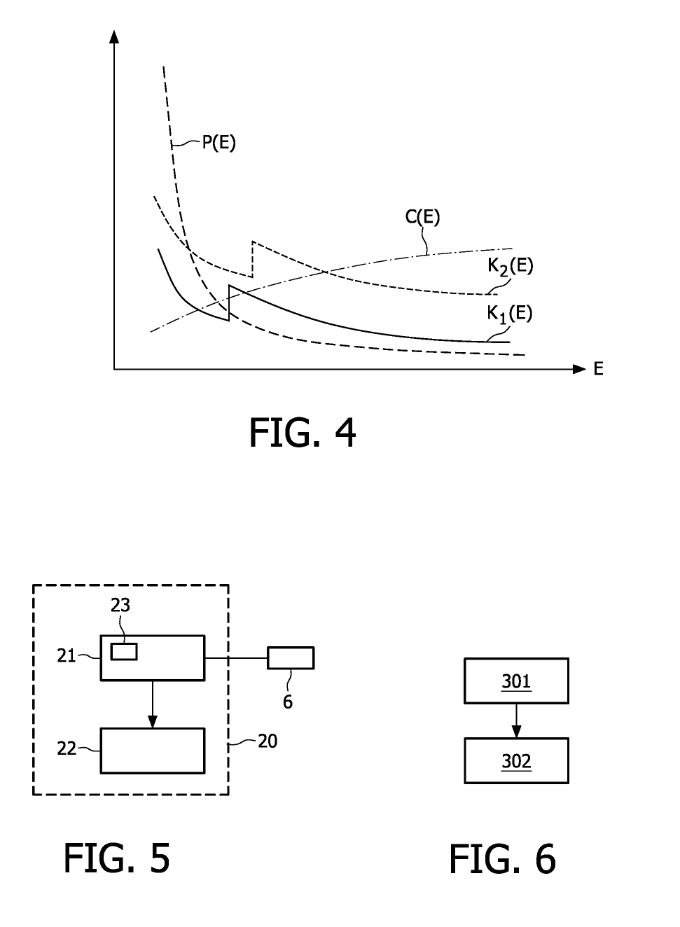

The emission spectrum D₀(E) of the polychromatic X-ray tube 2 is generally known (e.g. by simulations) or can be measured in advance. An example of such an emission spectrum D₀(E) of a polychromatic X-ray tube is schematically shown in FIG. 3. The attenuation coefficients of the photo-electric effect P(E), the Compton effect C(E), the K-edge effect K₁ (E) of the first material and the K-edge effect K₂ (E) of the second material, which are in this embodiment the attenuation coefficients μⱼ (E), are also known and exemplary shown in FIG. 4.

The detection unit 6 is adapted such that it comprises at least as many energy bins bᵢ as the number of attenuation components, i.e. in this embodiment the detection unit 6 provides detection signals for at least four energy bins b₁ . . . b₄. In general, the detection unit 6 comprises at least N_{B} energy bins, with N_{B}≧2. In accordance with equation (4), a system of at least N_{B} non-linear equations is formed having N_{B} unknowns which are the integral mass densities Aⱼ of the attenuation components, which are denoted as density length products in the following. This system can be solved with known numerical methods by the calculation unit 12. If more than four energy bins are available, it is preferred to use a maximum likelihood approach that takes the noise statistics of the measurement into account. Generally, as many energy bins as attenuation components, i.e. in this embodiment four energy bins, are sufficient. In order to increase the sensitivity and noise robustness, however, it is preferred to have more detection signals for more energy bins.

Each energy bin comprises another detector energy weighting function ƒᵢ(E). The determined attenuation components, i.e. the determined density length products, are transmitted to the reconstruction unit 13. Since, the X-ray source 2 moves relative to the region of interest, the detection signals, and, therefore, the determined density length products, correspond to X-rays having traversed the region of interest in different angular directions. Thus, images of the mass density ρⱼ of the different attenuation components can be reconstructed by using known CT reconstruction methods, like a filtered backprojection of one of the density length products. For example, if only the density length product A_{K1-edge}, representing the component of the first material with a K-edge within the region of interest, is used for reconstructing an image of the region of interest, an image of the first material within the region of interest is reconstructed only, without being influenced by the other attenuation components. In addition, images from ρₚₕₒₜₒ, being the mass density of photo-electric component, from ρ_{Compton}, being the mass density of the Compton component, or ρ_{K2-edge} being the mass density of the K-edge component of the second material within the region of interest, can be reconstructed by only using one of the other density lengths products Aₚₕₒₜₒ, A_{Compton} or A_{K1-edge} respectively, wherein respective images are generated showing only the parts of the region of interest, which have contributed to the respective effects, i.e. the photo-electric effect, the Compton effect or the K-edge effect of the second material within the region of interest.

In the following, an apparatus for determining a detector energy weighting function of a detection unit and a corresponding method will be described in accordance with the invention.

FIG. 5 shows schematically an apparatus 20 for determining a detector energy weighting function of a detection unit. The apparatus 20 comprises a determination unit 21 for determining a spectral response function of the detection unit and a calculation unit 22 for determining the detector energy weighting function by integrating the product of the spectral response function of the detection unit and a given ideal detector energy weighting function.

The apparatus 20 performs a method for determining a detector energy weighting function of a detection unit, which will be described in the following in more detail with respect to the flowchart shown in FIG. 6.

In step 301 the determination unit 21 determines a spectral response function of the detection unit 6.

For the determination of the spectral response function the determination unit 21 comprises a radiation source 23, which is capable of illuminating the detection unit 6 with monochromatic radiation having adjustable wavelengths. The radiation source 23 comprises, for example, a synchrotron radiation source and a grating, like a crystal lattice, to provide monochromatic radiation and to vary the wavelength of the monochromatic radiation. The determination unit 21 is adapted such the detection unit 6 is successively illuminated with monochromatic radiation of different wavelengths of radiation source, i.e. the detection unit 6 is illuminated by monochromatic radiation of different wavelengths of the radiation source one after the other. Furthermore, the determination unit 21 is connected to the detection unit 6 and receives detection signals from the detection unit 6, while the detection unit 6 is illuminated successively with monochromatic radiation of different wavelengths. Thus, for each wavelength the determination unit 21 receives detection signals Mᵢ for a plurality of energy bins bᵢ and detector pixels (especially neighbouring). The detection signals, which have been detected, while the detection unit has been illuminated successively by different wavelengths, form the spectral response function of the detection unit 6, wherein the spectral response function is preferentially normalized by the intensity of the monochromatic radiation impinging on the detection unit 6.

In another embodiment, the determination unit is adapted for determining the spectral response function by simulating detection signals of the detection unit, which would be detected, if the detection unit is illuminated successively with monochromatic radiation of different wavelengths. Such a simulation considers the known physical and/or electronic effects of the detection unit 6, like charge sharing and crosstalk, and is, for example, disclosed in A. Zumbiehl et al., “Modelling and 3D optimisation of CdTe pixels detector array geometry—Extension to small pixels”, Nucl. Instr. and Meth. A 469 (2001) 227-239.

If the simulation is used for determining the spectral response function of the detection unit 6, the spectral response function corresponds to the detection signals for the plurality of energy bins, which are simulated, if monochromatic radiation of a certain wavelength is simulated to impinge on the detection unit 6.

The determined spectral response function has following property. If monochromatic radiation of a certain wavelength is inputted to the detection unit 6, the detection signals for the plurality of energy bins are the output of the spectral response function of the detection unit 6.

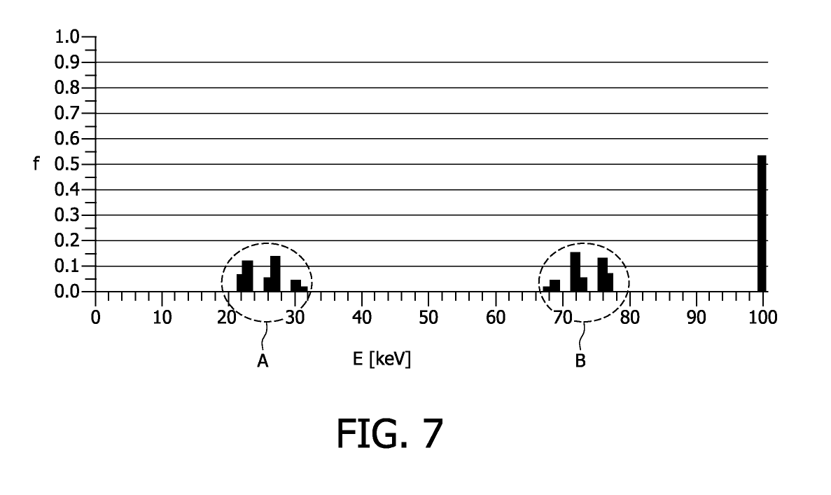

FIG. 7 shows schematically the spectral response function for X-ray photons having an incident energy of 100 keV. On the horizontal axis energy bins are shown, which have an energy width of 1 keV. On the vertical axis the probability of occurrence in the respective energy bin is shown. The probability of occurrence is normalized by the number of incident photons.

If the detection unit is an ideal detection unit, the normalized probability of occurrence would be 1.0 at 100 keV and 0 for the other energy bins. But, in reality, as can be seen in FIG. 7, due to detector effects, the spectral response function also shows unwished photons in energy regions A and B. These variations are, for example, caused by K-fluorescence or crosstalk. In the energy region A, those K-fluorescence photons are registered, which originate from an photo-absorption event outside (in the neighborhood) of the pixel of interest. In the region B, an originally 100 keV photon lost a part of the energy due to K-fluorescence, while the latter part is not registered in the same pixel of interest. These physical effects and further physical effects, like the “pile-up” effect or statistical effects, are present in a realistic detection unit 6 and cause the form of the spectral response function.

In a further embodiment, the determination unit 21 can be adapted such that the experimental determination of the spectral response function and the theoretical determination of the spectral response function by simulation are combined to improve the quality of the determined spectral response function. This can, for example, be achieved by measuring the spectral response function only for a few, for example, ten wavelengths, which are distributed over a predetermined energy range, and by simulating spectral response function values between the few wavelengths such that at the few wavelengths the simulated spectral response values coincide with the measured spectral response values.

In step 302, the calculation unit 22 determines the detector energy weighting function by integrating the product of the spectral response function of the detection unit and a given ideal detector energy weighting function, preferentially in accordance with the following equation:

$${f}_{i} ( E ) = {\int }_{0}^{∞} d {E}^{′} {f}_{i}^{id} ( {E}^{′} ) {f}_{SR} ( {E}^{′} , E ) \qquad ( 5 )$$

wherein ƒ^{id}(E′) is the ideal detector energy weighting function of an ideal detection unit and wherein ƒ_{sR} (E′, E) is the spectral response function, i.e. the spectrum, which is measured by the detection unit 6, if an incident photon has a monochromatic energy of E′.

If in other embodiments the detection unit comprises only one energy bin, energy dependent detection signals can be achieved by varying the spectrum impinging on the region of interest, for example, by varying the emission spectrum of the X-ray tube (tube voltage switching) or by using filters. If the spectrum of the radiation impinging on the region of interest is varied, a common detection unit, which is not energy-resolving, can be used for detecting energy dependent detection signals Mᵢ. In this case, equation (4) changes to the following equation:

$${M}_{i} = {c}_{i} \cdot {\int }_{{E}_{l}}^{{E}_{u}} d Ef ( E ) {D}_{0 , i} ( E ) \cdot exp ( - {\sum }_{j = 1}^{{N}_{B}} {A}_{j} \cdot {μ}_{j} ( E ) ) . \qquad ( 6 )$$

Each detection signal Mᵢ corresponds to a spectrum D_{0,i} (E) impinging on the region of interest. Thus, equation (6) describes a system of equations, which can be used to determine the density length products of the different attenuation components, if at least as many different spectra D_{0,i} (E) impinge on the region of interest as unknown density length products, i.e. attenuation components, are present. Therefore, in the example described in equation (6), at least N_{B} different spectra impinging on the region of interest have be to used. This system of equations can be solved to determine the density length products by using the methods described above with respect to equation (4).

In equation (6), the detector energy weighting function ƒ (E) is the detector energy weighting function in accordance with the invention, as defined in equation (4), wherein the spectral response function ƒ_{sR} (E′, E) is determined by a simulation.

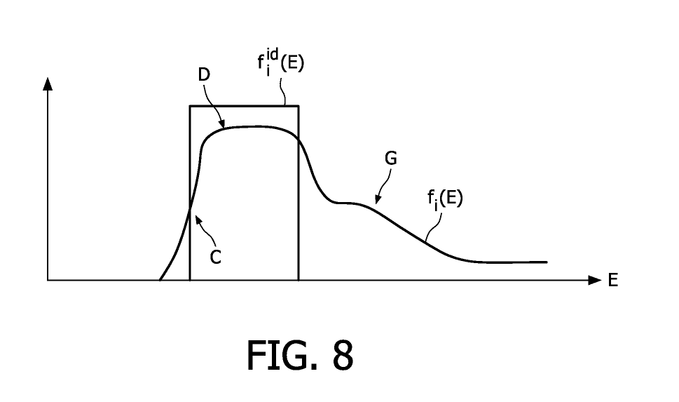

FIG. 8 shows schematically an ideal detector energy weighting function θᵢ^{id} (E) and a determined realistic detector energy weighting function ƒᵢ (E) in accordance with the invention. In the region denoted by “C” the edges of the ideal detector energy weighting function are smoothed because of energy broadening. In the region denoted by “D” the detector energy weighting function is lower due to energy loss (K escape, crosstalk), and the part of the detector energy weighting function denoted by “G” is caused by higher photon energies after K-fluorescence emission. Also further effects of the detection unit (e.g. due to special electronic properties) can contribute to the realistic weighting function.

Although a preferred embodiment of the invention has been described with respect to a spectral CT system, the invention is not limited to the use of a spectral CT system. For example, also other spectral X-ray applications can be used. Furthermore, the invention can also be used to determine the detector energy weighting function of a detection unit, which is not energy-resolving, for example, by computer simulation of the detector physics and the determination of the spectral response function.

Although special attenuation coefficients μⱼ (E) and attenuation components have been described above, arbitrary attenuation coefficients and corresponding attenuation components can be used, which constitute the attenuation of the object. At least two base functions together with at least two energy bins can be used for determining the attenuation components, in particular the integrated mass densities, wherein the determined attenuation components, in particular the determined integrated mass densities, are used for reconstruction. The reconstruction can, for example, be performed, by using the method described above or the method described in “Basis Material Decomposition Using Triple—Energy X-ray computed tomography”, P. Sukovic et al., IEEE IMTC 1999, which is herewith incorporated by reference.

The term “integrating” also includes summations, which correspond to an integration and which are, for example, performed, because the values, which are used for the integration, are discrete values.

Other variations to the disclosed embodiments can be understood and effected by those skilled in the art and practicing the claimed invention, from a study of the drawing, the disclosure and the dependent claims. In the claims, the word “comprising” does not exclude other elements or steps, and the indifferent article “a” or “an” does not exclude a plurality.

A single unit may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium, supplied together with or as part of other hardware, but may also be distributed in another form such as via the internet or other wired or wireless telecommunication systems.

Any reference signs in the claims should not be construed as limiting the scope.

1. An apparatus for determining a detector energy weighting function of a detection unit, the apparatus comprising:
a determination unit for determining a spectral response function of the detection unit,
a calculation unit for determining the detector energy weighting function by integrating the product of the spectral response function of the detection unit and a given ideal detector energy weighting function.

2. The apparatus as claimed in claim 1,
wherein the determination unit comprises a radiation source capable of illuminating the detection unit with monochromatic radiation having an adjustable wavelength,
wherein the determination unit is adapted for illuminating the detection unit successively with monochromatic radiation of different wavelengths of the radiation source,
wherein the determination unit is adapted for determining the spectral response function by detecting detection signals of the detection unit while being illuminated successively with monochromatic radiation of different wavelengths.

3. The apparatus as claimed in claim 1,
wherein the determination unit is adapted for determining the spectral response function by simulating detection signals of the detection unit, which would be detected, if the detection unit is illuminated successively with monochromatic radiation of different wavelengths.

4. The apparatus as claimed in claim 1,
wherein the detection unit is adapted for providing energy-resolved detection signals for a plurality of energy bins,
wherein the apparatus is adapted for determining for each energy bin a detector energy weighting function,
wherein the calculation unit is adapted for determining the detector energy weighting function for an energy bin by integrating the product of the spectral response function of the detection unit and a given ideal detector energy weighting function of the respective energy bin.

5. The apparatus as claimed in claim 4,
wherein the calculation unit is adapted such that the given ideal detector energy weighting function of an energy bin is one for energies within the respective energy bin and zero for energies outside of the respective energy bin.

6. An imaging system for imaging a region of interest, the imaging system comprising:
a radiation-and-detection unit comprising a radiation unit for emitting radiation and a detection unit for detecting the radiation after passing through the region of interest, the radiation-and-detection unit being adapted for generating a plurality of energy dependent detection signals, the detection signals comprising different components, the imaging system being provided with a detector energy weighting function, the detector energy weighting function being determined by determining a spectral response function of the detection unit and by integrating the product of the spectral response function of the detection unit and a given ideal detector energy weighting function,
a calculation unit for determining at least one attenuation component by solving a system of equations for the plurality of energy dependent detection signals, using a model for the detection signals describing a detection signal as a combination of the detector energy weighting function and of different attenuation properties contributing with corresponding attenuation components to the detection signal,
a reconstruction unit for reconstructing an image of the region of interest from the determined at least one attenuation component.

7. The imaging system as defined in claim 6,
wherein the radiation unit is a polychromatic radiation source for emitting polychromatic radiation,
wherein the detection unit is an energy-resolving detector for detecting the radiation after passing through the region of interest and for providing energy dependent detection signals by providing a plurality of energy-resolved detection signals for a plurality of energy bins, the imaging system being provided with a detector energy weighting function for each energy bin, the detector energy weighting function of an energy bin being determined by determining a spectral response function of the detection unit and by determining a detector energy weighting function of an energy bin by integrating the product of the spectral response function of the detection unit and a given ideal detector energy weighting function of the respective energy bin.

8. The imaging system as defined in claim 6,
wherein the radiation unit is a polychromatic radiation source for emitting polychromatic radiation, wherein the spectrum of the polychromatic radiation is changeable, wherein the radiation-and-detection unit is adapted for providing energy dependent detection signals by illuminating the region of interest by different spectra of polychromatic radiation and by detecting the radiation having the different spectra of polychromatic radiation after passing through the region of interest.

9. A method for determining a detector energy weighting function of a detection unit, the method comprising following steps:
determining a spectral response function of the detection unit by a determination unit,
determining the detector energy weighting function by integrating the product of the spectral response function of the detection unit and a given ideal detector energy weighting function by a calculation unit.

10. An imaging method for imaging a region of interest, the imaging method comprising:
emitting radiation by a radiation unit of a radiation-and-detection unit and detecting the radiation after passing through the region of interest by a detection unit of the radiation-and-detection unit, generating a plurality of energy dependent detection signals by the radiation-and-detection unit, the detection signals comprising different components, the imaging system being provided with a detector energy weighting function, the detector energy weighting function being determined by determining a spectral response function of the detection unit and by integrating the product of the spectral response function of the detection unit and a given ideal detector energy weighting function,
determining at least one attenuation component by solving a system for equations of the plurality for energy dependent detection signals, using a model for the detection signals describing a detection signal as a combination of the detector energy weighting function and of different attenuation properties contributing with corresponding attenuation components to the detection signal by a calculation unit,
reconstructing an image of the region of interest from the determined at least one attenuation component by a reconstructing unit.

11. A computer program stored on a computer readable medium for determining a detector energy weighting function of a detection unit, comprising program code means for causing a computer to carry out the steps of the method as claimed in claim 9.

12. A computer program stored on a computer readable medium for imaging a region of interest, comprising program code means for causing a computer to carry out the steps of the method as claimed in claim 10.
